(19) United States
(12) Patent Application Publication
(10) Pub. No.: US 2006/0148361 A1
(43) Pub. Date: Jul. 6, 2006

(54) Method for forming an elastic laminate

(75) Inventors: Wing-Chak Ng, Suwanee, GA (US); Ann Louise McCormack, Cumming, GA (US); Susan Elaine Shawver, Roswell, GA (US)

Correspondence Address: DORITY & MANNING, P.A., POST OFFICE BOX 1449, GREENVILLE, SC, 29602-1449, US

(73) Assignee: Kimberley-Clark Worldwide, inc.

(21) Appl. No.: 11/027,285

(22) Filed: Dec. 30, 2004

(51) Int. Cl. D04H 13/00; B32B 27/12; B32B 37/00

(52) U.S. Cl. 442/394; 442/328; 156/494

(57) ABSTRACT

An efficient, in-line method for forming an elastic laminate is provided. To form the laminate, a polymer composition containing an elastomeric polymer is extruded as a film. In one embodiment, the film is uniaxially oriented in the machine direction (“MD”), or optionally, biaxially oriented in the machine direction and the cross-machine direction (“CD”). Regardless, the elastic film is then laminated to a nonwoven web material. Prior to lamination, the percent stretch of the nonwoven web material is generally no more than 25% when 500 grams-force is applied per 3 inches of the material in either the cross-machine or machine direction. Such a relatively inextensible nonwoven web material may restrict the overall extensibility of the laminate. Thus, to improve extensibility, the resulting laminate is mechanically stretched in the cross-machine and/or machine directions. Extensibility may also be improved by allowing the laminate to relax and retract prior to winding so that the nonwoven web material gathers or forms buckles.

### BACKGROUND OF THE INVENTION

Many medical care products, protective wear garments, mortuary and veterinary products, and personal care products are currently available as disposable products. By disposable, it is meant that the product is used only a few times, or even only once, before being discarded. Examples of such products include, but are not limited to, medical and health care products (e.g., surgical drapes, gowns and bandages), protective workwear garments (e.g., coveralls and lab coats), and infant, child and adult personal care absorbent products (e.g., diapers, training pants, incontinence garments and pads, sanitary napkins, wipes, etc.), and so forth. These products are manufactured at a cost consistent with single- or limited-use disposability. Because their manufacture is often inexpensive relative to the cost of woven or knitted components, nonwoven webs may be utilized as a component of these disposable products. A film or layer of microfibers may also be used to impart liquid barrier properties, while an elastic layer (e.g., elastic film or elastic microfibers) may be used to impart additional properties of stretch and recovery. However, elastic films and layers often have unpleasant tactile aesthetic properties, such as feeling rubbery or tacky to the touch, making them unpleasant and uncomfortable against the wearer's skin. Inelastic nonwoven webs, on the other hand, have better tactile, comfort and aesthetic properties.

The tactile aesthetic properties of elastic films may be improved by forming a laminate of an elastic film with one or more non-elastic materials, such as nonwoven webs, on the outer surface of the elastic material. However, nonwoven webs formed from non-elastomeric polymers, such as polyolefins, are generally considered non-elastic and may have poor extensibility. When non-elastic nonwoven webs are laminated to elastic materials, the resulting laminate may also be restricted in its elastic properties. Therefore, laminates of elastic materials and nonwoven webs have been developed in which the nonwoven webs are made extensible by various processes, such as necking or gathering.

A need still exists, however, for a production method that is capable of producing a variety of elastic laminates in a less expensive manner, consistent with the costs dictated by the disposable applications for items employed in limited- or single-use disposable products. For example, a need exists for an efficient “in-line” production method that is capable of producing a wide variety of elastic laminates.

### SUMMARY OF THE INVENTION

In accordance with one embodiment of the present invention, a method for forming an elastic laminate is disclosed. The method comprises forming (e.g., casting, blowing, flat die extruding, etc.) an elastic film from a polymer composition that comprises an elastomeric polymer; bonding the elastic film to a nonwoven web material to form a laminate, wherein the nonwoven web material has a percent stretch of no more than 25% when applied with 500 grams-force per 3 inches of said material in the cross-machine or the machine direction; and mechanically stretching the laminate in at least one direction.

In accordance with another embodiment of the present invention, a method for forming an elastic laminate is disclosed. The method comprises forming an elastic film from a polymer composition that comprises an elastomeric polymer; orienting the film in the machine direction to form a uniaxially-stretched elastic film; bonding the elastic film to a nonwoven web material to form a laminate, wherein the nonwoven web material has a percent stretch of no more than 25% when applied with 500 grams-force per 3 inches of said material in the cross-machine direction; and passing the laminate through a nip formed between at least two grooved rolls to incrementally stretch the laminate in the cross-machine direction.

In accordance with still another embodiment of the present invention, a method for forming an elastic laminate is disclosed. The method comprises forming an elastic film from a polymer composition that comprises an elastomeric polymer; orienting the film in the machine direction to form a uniaxially-stretched elastic film; bonding the elastic film to first and second nonwoven web materials to form a laminate, wherein at least one of the nonwoven web materials has a percent stretch of no more than 25% when applied with 500 grams-force per 3 inches of said material in the cross-machine direction; and passing the laminate through a nip formed between at least two grooved rolls to incrementally stretch the laminate in the cross-machine direction.

Other features and aspects of the present invention are described in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 schematically illustrates a method for forming a laminate according to one embodiment of the present invention;

FIG. 2 is a perspective view of three of the grooved rolls shown in FIG. 1; and

FIG. 3 is a cross-sectional view showing the engagement between two of the grooved rolls of FIG. 1.

Repeat use of reference characters in the present specification and drawings is intended to represent same or analogous features or elements of the invention.

### DETAILED DESCRIPTION OF REPRESENTATIVE EMBODIMENTS

### Definitions

As used herein, the term “polymer” generally includes but is not limited to, homopolymers, copolymers, such as block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic and random symmetries. As used herein the term “thermoplastic” or “thermoplastic polymer” generally refers to polymers that will soften and flow or melt when heat and/or pressure are applied, the changes being reversible.

As used herein, the term “fibers” generally refers to both staple length fibers and substantially continuous filaments, and likewise includes monocomponent and multicomponent fibers. As used herein the term “substantially continuous” generally refers to a filament having a length much greater than its diameter, for example having a length to diameter ratio in excess of about 15,000 to 1, and desirably in excess of 50,000 to 1.

As used herein the term “nonwoven fabric or web” generally refers to a web having a structure of individual fibers or threads which are interlaid, but not in an identifiable manner as in a knitted fabric. Examples of suitable nonwoven fabrics or webs include, but are not limited to, meltblown webs, spunbond webs, carded webs, etc.

As used herein, the term “meltblown web” generally refers to a nonwoven web that is formed by a process in which a molten thermoplastic material is extruded through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, et al., which is incorporated herein in its entirety by reference thereto for all purposes. Generally speaking, meltblown fibers may be microfibers that are substantially continuous or discontinuous, generally smaller than 10 microns in diameter, and generally tacky when deposited onto a collecting surface.

As used herein, the term “spunbond web” generally refers to a web containing small diameter substantially continuous fibers. The fibers are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spunbond webs is described and illustrated, for example, in U.S. Pat. Nos. 4,340,563 to Appel, et al., 3,692,618 to Dorschner, et al., 3,802,817 to Matsuki, et al., 3,338,992 to Kinney, 3,341,394 to Kinney, 3,502,763 to Hartman, 3,502,538 to Levy, 3,542,615 to Dobo, et al., and 5,382,400 to Pike, et al., which are incorporated herein in their entirety by reference thereto for all purposes. Spunbond fibers are generally not tacky when they are deposited onto a collecting surface. Spunbond fibers may sometimes have diameters less than about 40 microns, and are often between about 5 to about 20 microns.

As used herein, “carded web” generally refers to a nonwoven web formed by carding processes as are known to those skilled in the art and further described, for example, in U.S. Pat. No.4,488,928 to Alikhan, which is incorporated herein in its entirety by reference thereto for all purposes. Briefly, carding processes involve starting with staple fibers in a bulky batt that are separated, combed or otherwise treated and then deposited to provide a web of generally uniform basis weight.

As used herein, the terms “machine direction” or “MD” generally refers to the direction in which a material is produced. The term “cross-machine direction” or “CD” refers to the direction perpendicular to the machine direction. Dimensions measured in the cross-machine direction are referred to as “width” dimension, while dimensions measured in the machine direction are referred to as “length” dimensions.

As used herein the terms “extensible” or “extensibility” generally refers to a material that stretches or extends in the direction of an applied force by at least about 50% of its relaxed length or width. An extensible material does not necessarily have recovery properties. For example, an elastomeric material is an extensible material having recovery properties. A meltblown web may be extensible, but not have recovery properties, and thus, be an extensible, non-elastic material.

As used herein, the term “elastomeric” and “elastic” and refers to a material that, upon application of a stretching force, is stretchable in at least one direction (such as the CD direction), and which upon release of the stretching force, contracts/returns to approximately its original dimension. For example, a stretched material may have a stretched length that is at least 50% greater than its relaxed unstretched length, and which will recover to within at least 50% of its stretched length upon release of the stretching force. A hypothetical example would be a one (1) inch sample of a material that is stretchable to at least 1.50 inches and which, upon release of the stretching force, will recover to a length of not more than 1.25 inches. Desirably, such elastomeric sheet contracts or recovers at least 50%, and even more desirably, at least 80% of the stretch length in the cross machine direction.

As used herein, the terms “necked” and “necked material” generally refer to any material that has been drawn in at least one dimension (e.g., machine direction) to reduce its transverse dimension (e.g., cross-machine direction) so that when the drawing force is removed, the material may be pulled back to its original width. The necked material generally has a higher basis weight per unit area than the un-necked material. When the necked material is pulled back to its original width, it should have about the same basis weight as the un-necked material. This differs from the orientation of a film in which the film is thinned and the basis weight is reduced. The necking method typically involves unwinding a material from a supply roll and passing it through a brake nip roll assembly driven at a given linear speed. A take-up roll or nip, operating at a linear speed higher than the brake nip roll, draws the material and generates the tension needed to elongate and neck the material.

As used herein, the term “set” refers to retained elongation in a material sample following the elongation and recovery, i.e., after the material has been stretched and allowed to relax during a cycle test.

As used herein, the term “percent set” is the measure of the amount of the material stretched from its original length after being cycled (the immediate deformation following the cycle test). The percent set is where the retraction curve of a cycle crosses the elongation axis. The remaining strain after the removal of the applied stress is measured as the percent set.

As used herein, the term “percent stretch” refers to the degree to which a material stretches in a given direction when subjected to a certain force. In particular, percent stretch is determined by measuring the increase in length of the material in the stretched dimension, dividing that value by the original dimension of the material, and then multiplying by 100. Such measurements are determined using the “strip elongation test”, which is substantially in accordance with the specifications of ASTM D5035-95. Specifically, the test uses two clamps, each having two jaws with each jaw having a facing in contact with the sample. The clamps hold the material in the same plane, usually vertically, separated by 3 inches and move apart at a specified rate of extension. The sample size is 3 inches by 6 inches, with a jaw facing height of 1 inch and width of 3 inches, and a constant rate of extension of 300 mm/min. The specimen is clamped in, for example, a Sintech 2/S tester with a Renew MTS mongoose box (control) and using TESTWORKS 4.07b software (Sintech Corp, of Cary, N.C.). The test is conducted under ambient conditions. Results are generally reported as an average of three specimens and may be performed with the specimen in the cross direction (CD) and/or the machine direction (MD).

As used herein, the “hysteresis” value of a sample may be determined by first elongating the sample to a percent stretch of 50%, and then allowing the sample to retract to an amount where the amount of resistance is zero. The hysteresis values may, for example, be read at the 30% and 50% percent stretch in the cross-machine direction.

As used herein, the term “breathability” generally refers to the water vapor transmission rate (WVTR) of an area of a material. Breathability is measured in grams of water per square meter per day (gm²/24 hours). The WVTR of a material may be measured in accordance with ASTM Standard E96-80. Alternatively, for materials having WVTR greater than about 3000 g/m²/24 hours testing systems such as, for example, the PERMATRAN-W 100K water vapor permeation analysis system, commercially available from Modern Controls, Inc. (MOCON) of Minneapolis, Minn., may be used. Further, as used herein the term “breathable” refers to a fabric having a WVTR of at least 300 g/m²/24 hours.

### Detailed Description

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

In general, the present invention is directed to an efficient, in-line method for forming an elastic laminate. To form the laminate, a polymer composition containing an elastomeric polymer is extruded as a film. In one embodiment, the film is uniaxially oriented in the machine direction (“MD”), or optionally, biaxially oriented in the machine direction and the cross-machine direction (“CD”). Regardless, the elastic film is then laminated to a nonwoven web material. Prior to lamination, the percent stretch of the nonwoven web material is generally no more than 25% when applied with 500 grams-force per 3 inches of the material in either the cross-machine or machine direction. Such a relatively inextensible nonwoven web material may restrict the overall extensibility of the laminate. Thus, to improve extensibility, the resulting laminate is mechanically stretched in the cross-machine and/or machine directions. Extensibility may also be improved by allowing the laminate to relax and retract prior to winding so that the nonwoven web material gathers or forms buckles.

The elastic film may generally be formed by any of a number of conventionally known processes, including flat die extrusion, blown film (tubular) process, casting, etc. The film may be mono- or multilayered. Multilayered films, for instance, may be prepared by co-extrusion of the layers, extrusion coating, or by any conventional layering process. Regardless, the viscosity of the polymers used to form the film may generally vary depending on the selected film-forming process. Viscosity is often gauged by the melt flow rate of a polymer, which is determined using well-known techniques as described in ASTM D 1238. Specifically, melt flow rate is inversely related to viscosity, and thus increases as viscosity decreases. In most embodiments of the present invention, for instance, the melt flow rate of the elastomeric polymers is greater than about 1.0 gram per 10 minutes (g/10 min). For example, when extruded as a cast film, lower viscosity elastomeric polymers are typically desired, such as those having a melt flow rate of greater than about 5.0 g/10 min. Likewise, when formed as a blown film, higher viscosity elastomeric polymers are typically desired, such as those having a melt flow rate of less than about 5.0 g/10 min.

Some suitable elastomeric polymers for forming the elastic film include, but are not limited to, elastomeric polyesters, elastomeric polyurethanes, elastomeric polyamides, elastomeric polyolefins, elastomeric copolymers, and so forth. Examples of elastomeric copolymers include block copolymers having the general formula A-B-A′ or A-B, wherein A and A′ are each a thermoplastic polymer endblock that contains a styrenic moiety and B is an elastomeric polymer midblock, such as a conjugated diene or a lower alkene polymer. Such copolymers may include, for instance, styrene-isoprene-styrene (S-I-S), styrene-butadiene-styrene (S-B-S), styrene-ethylene-butylene-styrene (S-EB-S), styrene-isoprene (S-I), styrene-butadiene (S-B), and so forth. Commercially available A-B-A′ and A-B-A-B copolymers include several different S-EB-S formulations from Kraton Polymers of Houston, Tex. under the trade designation KRATON®. KRATON® block copolymers are available in several different formulations, a number of which are identified in U.S. Pat. Nos. 4,663,220, 4,323,534, 4,834,738, 5,093,422 and 5,304,599, which are hereby incorporated in their entirety by reference thereto for all purposes. Other commercially available block copolymers include the S-EP-S elastomeric copolymers available from Kuraray Company, Ltd. of Okayama, Japan, under the trade designation SEPTON®. Still other suitable copolymers include the S-I-S and S-B-S elastomeric copolymers available from Dexco Polymers of Houston, Tex. under the trade designation VECTOR®. Also suitable are polymers composed of an A-B-A-B tetrablock copolymer, such as discussed in U.S. Pat. No. 5,332,613 to TaVior, et al., which is incorporated herein in its entirety by reference thereto for all purposes. An example of such a tetrablock copolymer is a styrene-poly(ethylene-propylene)-styrene-poly(ethylene-propylene) (“S-EP-S-EP”) block copolymer.

Examples of elastomeric polyolefins include ultra-low density elastomeric polypropylenes and polyethylenes, such as those produced by “single-site” or “metallocene” catalysis methods. Such elastomeric olefin polymers are commercially available from ExxonMobil Chemical Co. of Houston, Tex. under the trade designations ACHIEVE® (propylene-based), EXACT® (ethylene-based), and EXCEED® (ethylene-based). Elastomeric olefin polymers are also commercially available from DuPont Dow Elastomers, LLC (a joint venture between DuPont and the Dow Chemical Co.) under the trade designation ENGAGE® (ethylene-based) and from Dow Chemical Co. of Midland, Mich. under the name AFFINITY® (ethylene-based). Examples of such polymers are also described in U.S. Pat. Nos. 5,278,272 and 5,272,236 to Lai, et al., which are incorporated herein in their entirety by reference thereto for all purposes. Also useful are certain elastomeric polypropylenes, such as described in U.S. Pat. Nos. 5,539,056 to Yang, et al. and 5,596,052 to Resconi, et al., which are incorporated herein in their entirety by reference thereto for all purposes.

If desired, blends of two or more polymers may also be utilized to form the elastic film in accordance with the present invention. For example, the elastic film may be formed from a blend of a high performance elastomer and a lower performance elastomer. A high performance elastomer is generally an elastomer having a low level of hysteresis, such as less than about 75%, and in some embodiments, less than about 60%. Likewise, a low performance elastomer is generally an elastomer having a high level of hysteresis, such as greater than about 75%. Particularly suitable high performance elastomers may include styrenic-based block copolymers, such as described above and commercially available from Kraton Polymers under the trade designation KRATON(® and from Dexco Polymers under the trade designation VECTOR®. Likewise, particularly suitable low performance elastomers include elastomeric polyolefins, such as metallocene-catalyzed polyolefins (e.g., single site metallocene-catalyzed linear low density polyethylene) commercially available from Dow Chemical Co. under the trade designation AFFINITY®. In some embodiments, the high performance elastomer may constitute from about 25 wt. % to about 90 wt. % of the polymer component of the film, and the low performance elastomer may likewise constitute from about 10 wt. % to about 75 wt. % of the polymer component of the film. Further examples of such a high performance/low performance elastomer blend are described in U.S. Pat. No. 6,794,024 to Walton, et al., which is incorporated herein in its entirety by reference thereto for all purposes.

Elastic films may be “liquid- and vapor-impermeable” and thus act as a barrier to the passage of liquids, vapors, and gases. In some embodiments of the present invention, it is also desired that the elastic film layer is “breathable” to allow the passage of water vapor and/or gases, which may provide increased comfort to a wearer by reducing excessive skin hydration and providing a cooler feeling. For example, the thermoplastic elastic material may be a breathable monolithic film that acts as a barrier to the passage of aqueous liquids, yet allows the passage of water vapor and air or other gases. Monolithic films are non-porous and have passages with cross-sectional sizes on a molecular scale formed by a polymerization process. The passages serve as conduits by which water molecules (or other liquid molecules) may disseminate through the film. Vapor transmission occurs through a monolithic film as a result of a concentration gradient across the monolithic film. As water (or other liquid) evaporates on the body side of the film, the concentration of water vapor increases. The water vapor condenses and dissolves on the surface of the body side of the film. As a liquid, the water molecules dissolve into the film. The water molecules then diffuse through the monolithic film and re-evaporate into the air on the side having a lower water vapor concentration. Monolithic breathable films are generally formed from polymers that inherently have good water vapor transmission or diffusion rates, such as polyurethanes, polyether esters, polyether amides, EMA, EEA, EVA, and so forth. Suitable examples of elastic breathable monolithic films are described in U.S. Pat. No. 6,245,401 to Ying, et al., which is incorporated herein in its entirety by reference thereto for all purposes.

Microporous elastic films may also be used. The micropores form what is often referred to as tortuous pathways through the film. Liquid contacting one side of the film does not have a direct passage through the film. Instead, a network of microporous channels in the film prevents liquids from passing, but allows gases and water vapor to pass. Microporous films may be formed from a polymer and a filler. Fillers are particulates or other forms of material that may be added to the film polymer extrusion blend and that will not chemically interfere with the extruded film, but which may be uniformly dispersed throughout the film. Generally, the fillers have a spherical or non-spherical shape with average particle sizes in the range of from about 0.1 to about 7 microns. Examples of suitable fillers include, but are not limited to, calcium carbonate, various kinds of clay, silica, alumina, barium carbonate, sodium carbonate, magnesium carbonate, talc, barium sulfate, magnesium sulfate, aluminum sulfate, titanium dioxide, zeolites, cellulose-type powders, kaolin, mica, carbon, calcium oxide, magnesium oxide, aluminum hydroxide, pulp powder, wood powder, cellulose derivatives, chitin and chitin derivatives. A suitable coating, such as stearic acid, may also be applied to the filler particles if desired. The films are made breathable by stretching the filled films to create the microporous passageways as the polymer breaks away from the calcium carbonate during stretching. For example, the breathable material contains a stretch-thinned film that includes at least two basic components, i.e., a polyolefin polymer and filler. These components are mixed together, heated, and then cast into a film. Stretching of the film may be accomplished, for instance, using a machine direction orienter, such as described below.

Breathable microporous elastic films containing fillers are described, for example, in U.S. Pat. Nos. 6,015,764 and 6,111,163 to McCormack, et al.; 5,932,497 to Morman, et al.; 6,461,457 to Taylor, et al., which are incorporated herein in their entirety by reference thereto for all purposes. Other breathable films having bonding agents are disclosed in U.S. Pat. Nos. 5,855,999 and 5,695,868 to McCormack, which are incorporated herein in their entirety by reference thereto for all purposes. In addition, exemplary multilayer breathable films are disclosed in U.S. Pat. No. 5,997,981 to McCormack et al., which is incorporated herein in its entirety by reference thereto for all purposes.

In yet another embodiment of the invention, a cellular elastic film may be used to provide breathability. Breathable cellular elastic films may be produced by mixing the elastomeric polymer resin with a cell-opening agent that decomposes or reacts to release a gas to form cells in the elastic film. The cell opening agent may be an azodicarbonamide, fluorocarbon, low boiling point solvent (e.g., methylene chloride, water, etc.) and other cell-opening or blowing agents known in the art to create a vapor at the temperature experienced in the film die extrusion process. Exemplary cellular elastic films are described in WO 00/39201 to Thomas et al., which is incorporated herein in its entirety by reference thereto for all purposes.

Breathability may also be imparted to the laminate without concern for its barrier properties. In such circumstances, either the elastic film itself or the entire elastic laminate may be apertured or perforated to provide a laminate capable of allowing the passage of vapors or gases. Such perforations or apertures may be performed by methods known in the art, such as slit aperturing or pin aperturing with heated or ambient temperature pins.

In accordance with the present invention, the elastic laminate also includes a nonwoven web material. Generally speaking, the nonwoven web material is relatively inextensible in one or more directions, such as the cross-machine direction. More specifically, the nonwoven web material has a percent stretch of no more than 25% when applied with 500 grams-force (gf) per 3 inches of the material in either the cross-machine or machine direction. In some cases, the nonwoven web material has a percent stretch of no more than 25% when applied with 750 gf per 3 inches of the material in either the cross-machine or machine direction. In still other cases, the nonwoven web material has a percent stretch of no more than 25% when applied with 1,000 gf per 3 inches of the material in either the cross-machine or machine direction. The above-described stretch characteristics are typically present in nonwoven webs that are formed from non-elastomeric polymers and that have not been subjected to any particular pre-treatment to improve extensibility (e.g., necking).

Examples of such nonwoven webs include, for example, spunbond webs (e.g., monocomponent or bicomponent), meltblown webs, and carded webs. Polymers suitable for making nonwoven webs include, for example, polyolefins, polyesters, polyamides, polycarbonates, copolymers and blends thereof, etc. Suitable polyolefins include polyethylene, such as high density polyethylene, medium density polyethylene, low density polyethylene, and linear low density polyethylene; polypropylene, such as isotactic polypropylene, atactic polypropylene, and syndiotactic polypropylene; polybutylene, such as poly(1-butene) and poly(2-butene); polypentene, such as poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, etc., as well as blends and copolymers thereof. Suitable polyesters include poly(lactide) and poly(lactic acid) polymers as well as polyethylene terephthalate, polybutylene terephthalate, polytetramethylene terephthalate, polycyclohexylene-1,4-dimethylene terephthalate, and isophthalate copolymers thereof, as well as blends thereof. It should be noted that the polymer(s) may also contain other additives, such as processing aids or treatment compositions to impart desired properties to the fibers, residual amounts of solvents, pigments or colorants, and so forth.

If desired, the nonwoven web material used to form the elastic laminate may itself have a multi-layer structure. Suitable multi-layered materials may include, for instance, spunbond/meltblown/spunbond (SMS) laminates and spunbond / meltblown (SM) laminates. Various examples of suitable SMS laminates are described in U.S. Pat. Nos. 4,041,203 to Brock et al.; 5,213,881 to Timmons, et al.; 5,464,688 to Timmons, et al.; 4,374,888 to Bornslaeger; 5,169,706 to Collier, et al.; and 4,766,029 to Brock et al., which are incorporated herein in their entirety by reference thereto for all purposes. In addition, commercially available SMS laminates may be obtained from Kimberly-Clark Corporation under the designations Spunguard® and Evolution®.

Another example of a multi-layered structure is a spunbond web produced on a multiple spin bank machine in which a spin bank deposits fibers over a layer of fibers deposited from a previous spin bank. Such an individual spunbond nonwoven web may also be thought of as a multi-layered structure. In this situation, the various layers of deposited fibers in the nonwoven web may be the same, or they may be different in basis weight and/or in terms of the composition, type, size, level of crimp, and/or shape of the fibers produced. As another example, a single nonwoven web may be provided as two or more individually produced layers of a spunbond web, a carded web, etc., which have been bonded together to form the nonwoven web. These individually produced layers may differ in terms of production method, basis weight, composition, and fibers as discussed above.

A nonwoven web material may also contain an additional fibrous component such that it is considered a composite. For example, a nonwoven web may be entangled with another fibrous component using any of a variety of entanglement techniques known in the art (e.g., hydraulic, air, mechanical, etc.). In one embodiment, the nonwoven web is integrally entangled with cellulosic fibers using hydraulic entanglement. A typical hydraulic entangling process utilizes high pressure jet streams of water to entangle fibers to form a highly entangled consolidated fibrous structure, e.g., a nonwoven fabric. Hydraulically entangled nonwoven fabrics of staple length and continuous fibers are disclosed, for example, in U.S. Pat. Nos. 3,494,821 to Evans and 4,144,370 to Boulton, which are incorporated herein in their entirety by reference thereto for all purposes. Hydraulically entangled composite nonwoven fabrics of a continuous fiber nonwoven web and a pulp layer are disclosed, for example, in U.S. Pat. Nos. 5,284,703 to Everhart, et al. and 6,315,864 to Anderson, et al., which are incorporated herein in their entirety by reference thereto for all purposes. The fibrous component of the composite may contain any desired amount of the resulting substrate. The fibrous component may contain greater than about 50% by weight of the composite, and in some embodiments, from about 60% to about 90% by weight of the composite. Likewise, the nonwoven web may contain less than about 50% by weight of the composite, and in some embodiments, from about 10% to about 40% by weight of the composite.

Regardless of the manner in which it is formed, the basis weight of the nonwoven web material may generally vary, such as from about 5 grams per square meter (“gsm”) to 100 gsm, in some embodiments from about 10 gsm to about 70 gsm, and in some embodiments, from about 15 gsm to about 35 gsm. Likewise, the basis weight of the elastic film may generally vary, such as from about 5 grams per square meter (“gsm”) to about 100 gsm, in some embodiments from about 5 gsm to about 70 gsm, and in some embodiments, from about 5 gsm to about 35 gsm. Because elastic materials are often expensive to produce, the basis weight of the elastic film may be as low as possible while still providing the desired properties of stretch and recovery to the elastic laminate.

Generally speaking, the nonwoven web material of the present invention remains relatively inextensible in at least one direction prior to lamination to the elastic film. The present invention instead achieves extensibility by mechanically stretching the material after it has been laminated to the elastic film. Such a method provides significant cost savings and manufacturing efficiencies in that a separate, pre-necking step for the nonwoven web material is not required. In this regard, various embodiments of the lamination method will now be described in greater detail. Of course, it should be understood that the description provided below is merely exemplary, and that other methods are contemplated by the present invention.

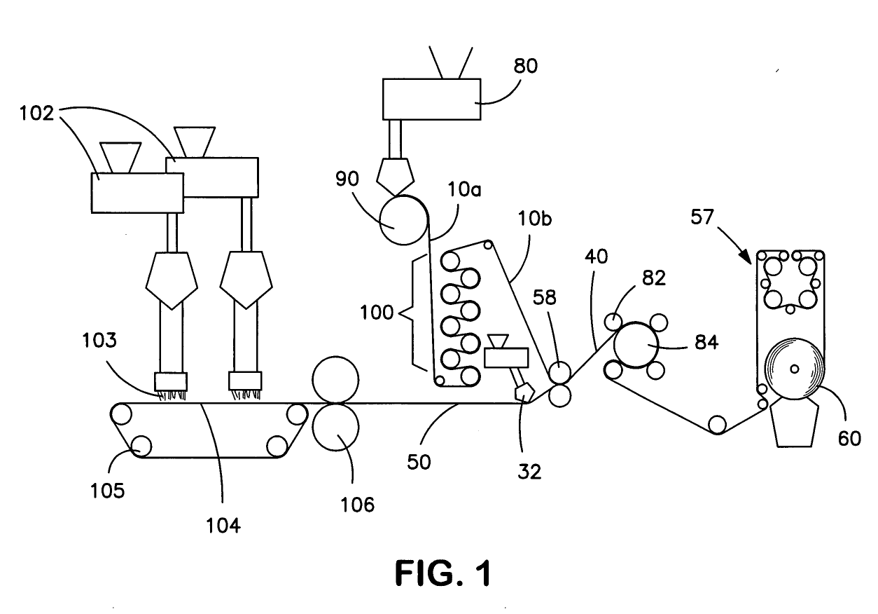

Referring to FIG. 1, for instance, one embodiment of a method for forming a laminate from an elastic film and a nonwoven web material is shown. Initially, the raw materials (e.g., polymers) for the elastic film are compounded through a method well known to those skilled in the art. For instance, the raw materials may be dry mixed together and added to a hopper of an extruder. In the hopper, the materials are dispersively mixed in the melt and conveyed by the action of an intermeshing rotating screw. Thereafter, the extruded material is immediately chilled and cut into pellet form. As stated above, any known technique may then be used to form a film from the compounded material, including blowing, casting, flat die extruding, etc. For example, in the particular embodiment of FIG. 1, the compounded material (not shown) is supplied to an extrusion apparatus 80 and then cast onto a casting roll 90 to form a single-layered precursor film 10a. If a multilayered film is to be produced, the multiple layers are co-extruded together onto the casting roll 90. The casting roll 90 may optionally be provided with embossing elements to impart a pattern to the film. Typically, the casting roll 90 is kept at temperature sufficient to solidify and quench the sheet 10a as it is formed, such as from about 20 to 60° C. If desired, a vacuum box may be positioned adjacent to the casting roll 90 to help keep the precursor film 10a close to the surface of the roll 90. Additionally, air knives or electrostatic pinners may help force the precursor film 10a against the surface of the casting roll 90 as it moves around a spinning roll. An air knife is a device known in the art that focuses a stream of air at a very high flow rate to pin the edges of the film.

Once cast, the elastic film 10a may then be oriented in one or more directions to further improve film uniformity and reduce thickness. Orientation may also form micropores in a film containing a filler, thus providing breathability to the film. One benefit of the present invention is that the film may be oriented in-line, without having to remove the film for separate processing. For example, the film may be immediately reheated to a temperature below the melting point of one or more polymers in the film, but high enough to enable the composition to be drawn or stretched. In the case of sequential orientation, the “softened” film is drawn by rolls rotating at different speeds of rotation such that the sheet is stretched to the desired draw ratio in the longitudinal direction (machine direction). This “uniaxially” oriented film may then be laminated to a fibrous web. In addition, the uniaxially oriented film may also be oriented in the cross-machine direction to form a “biaxially oriented” film. For example, the film may be clamped at its lateral edges by chain clips and conveyed into a tenter oven. In the tenter oven, the film may be reheated and drawn in the cross-machine direction to the desired draw ratio by chain clips diverged in their forward travel.

Referring again to FIG. 1, for instance, one method for forming a uniaxially oriented film is shown. As illustrated, the precursor film 10a is directed to a film-orientation unit 100 or machine direction orienter (“MDO”), such as commercially available from Marshall and Willams, Co. of Providence, R.I. The MDO has a plurality of stretching rolls (such as from 5 to 8) which progressively stretch and thin the film in the machine direction, which is the direction of travel of the film through the process as shown in FIG. 1. While the MDO 100 is illustrated with eight rolls, it should be understood that the number of rolls may be higher or lower, depending on the level of stretch that is desired and the degrees of stretching between each roll. The film may be stretched in either single or multiple discrete stretching operations. It should be noted that some of the rolls in an MDO apparatus may not be operating at progressively higher speeds. If desired, some of the rolls of the MDO 100 may act as preheat rolls. If present, these first few rolls heat the film 10a above room temperature (e.g., to 125° F.). The progressively faster speeds of adjacent rolls in the MDO act to stretch the film 10a. The rate at which the stretch rolls rotate determines the amount of stretch in the film and final film weight.

A nonwoven web is also employed for laminating to the oriented film 10b. For example, the nonwoven web may simply be unwound from a supply roll. Alternatively, as shown in FIG. 1, a nonwoven web 50 may be formed in-line, such as by spunbond extruders 102. The extruders 102 deposit fibers 103 onto a forming wire 104, which is part of a continuous belt arrangement that circulates around a series of rolls 105. If desired, a vacuum (not shown) may be utilized to maintain the fibers on the forming wire 104. The spunbond 103 fibers may also be compressed via compaction rolls 106. Following compaction, the nonwoven web material 50 is directed to a nip defined between rolls 58 for laminating to the film 10b.

Various techniques may be utilized to bond the film 10b to the nonwoven web 50, including adhesive bonding, such as through slot or spray adhesive systems; thermal bonding; ultrasonic bonding; microwave bonding; extrusion coating; and so forth. In FIG. 1, for instance, an adhesive bonding system 32 is employed. Examples of suitable adhesives that may be used in the present invention include Rextac 2730 and 2723 available from Huntsman Polymers of Houston, Tex., as well as adhesives available from Bostik Findley, Inc, of Wauwatosa, Wis. The basis weight of the adhesive may be between about 1.0 and 3.0 gsm. The type and basis weight of the adhesive used will be determined on the elastic attributes desired in the final laminate and end use. Although not required, the adhesive may be applied directly to the nonwoven web prior to lamination with the film. Further, to achieve improve drape, the adhesive may be applied in a pattern.

After the nonwoven web 50 and the film 10b are laminated together, the resulting laminate 40 is then mechanically stretched in the cross-machine and/or machine directions to enhance the extensibility of the laminate 40. For instance, the laminate may be coursed through two or more rolls that have grooves in the CD and/or MD directions. The grooved rolls may be constructed of steel or other hard material (such as a hard rubber). In the embodiment shown in FIG. 1, for instance, the laminate 40 is mechanically stretched in the cross-machine direction using a series of four satellite rolls 82 that each engage an anvil roll 84. Specifically, the laminate 40 is passed through a nip formed between each satellite roll 82 and the anvil roll 84 so that the laminate 40 is mechanically (incrementally) stretched in a cross-machine direction.

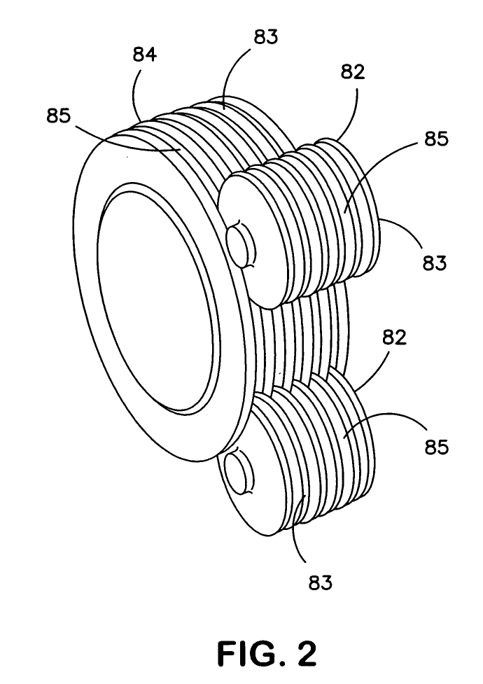

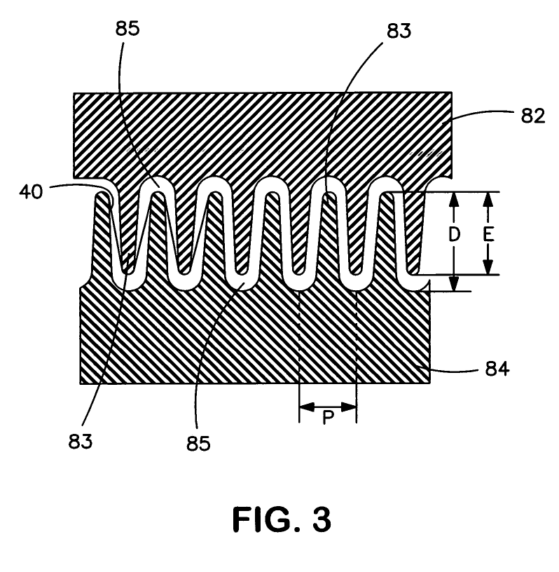

FIGS. 2-3 further illustrate the manner in which the satellite rolls 82 engage the anvil roll 84 are engaged. Specifically, the satellite rolls 82 and anvil roll 84 include a plurality of ridges 83 defining a plurality of grooves 85 positioned across the grooved rolls in the cross-machine direction. The grooves 85 are generally oriented perpendicular to the direction of stretch of the material. In other words, the grooves 85 are oriented in the machine direction to stretch the laminate 40 in the cross-machine direction. The grooves 85 may likewise be oriented in the cross-machine direction to stretch the laminate 40 in the machine direction. The ridges 83 of satellite roll 82 intermesh with the grooves 85 of anvil roll 84, and the grooves 85 of satellite roll 82 intermesh with the ridges 83 of anvil roll 84.

The dimensions and parameters of the grooves 85 and ridges 83 may have a substantial affect on the degree of extensibility provided by the rolls 82 and 84. For example, the number of grooves 85 contained on a roll may generally range from about 3 and 15 grooves per inch, in some embodiments from about 5 and 12 grooves per inch, and in some embodiments, from about 5 and 10 grooves per inch. The grooves 85 may also have a certain depth “D”, which generally ranges from about 0.25 to about 1.0 centimeter, and in some embodiments, from about 0.4 to about 0.6 centimeters. In addition, the peak-to-peak distance “P” between the grooves 85 is typically from about 0.1 to about 0.9 centimeters, and in some embodiments, from about 0.2 to about 0.5 centimeters. Also, the groove roll engagement distance “E” between the grooves 85 and ridges 83 may be up to about 0.8 centimeters, and in some embodiments, from about 0.15 to about 0.4 centimeters. Regardless, the laminate 40 is typically stretched in one or more directions from about 1.5× to about 8×, in some embodiments by at least about 2× to about 6×, and in some embodiments, from about 2.5× to about 4.5×. If desired, heat may be applied to the laminate 40 just prior to or during the application of incremental stretch to cause it to relax somewhat and ease extension. Heat may be applied by any suitable method known in the art, such as heated air, infrared heaters, heated nipped rolls, or partial wrapping of the laminate around one or more heated rolls or steam canisters, etc. Heat may also be applied to the grooved rolls themselves. Grooved satellite/anvil roll arrangements, such as described above, are also discussed in more detail in PCT Publication No. WO 04/020174 to Gerndt, et al., which is incorporated herein in its entirety by reference thereto for all purposes. It should also be understood that other grooved roll arrangement are equally suitable, such as two grooved rolls positioned immediately adjacent to one another.

Besides the above-described grooved rolls, other techniques may also be used to mechanically stretch the laminate 40 in one or more directions. For example, the laminate 40 may be passed through a tenter frame that stretches the laminate 40. Such tenter frames are well known in the art and described, for instance, in U.S. Patent Application Publication No. 2004/0121687 to Morman, et al. The laminate 40 may also be necked. Suitable techniques necking techniques are described in U.S. Pat. Nos. 5,336,545, 5,226,992, 4,981,747 and 4,965,122 to Morman, as well as U.S. Patent Application Publication No. 2004/0121687 to Morman, et al., all of which are incorporated herein in their entirety by reference thereto for all purposes.

Referring again to FIG. 1, the mechanically-stretched laminate 40 may then contact anneal rolls 57, which are heated to an annealing temperature (e.g., 35 to 60° C.) for the film. After annealing, another roll may also be employed that cools the film (e.g., to 10 to 30° C.) to set the final stretch properties. Thereafter, the laminate 40 may be wound up onto a take-up roll 60. Optionally, the laminate 40 may be allowed to slightly retract prior to winding on to a take-up roll 60. This may be achieved by using a slower linear velocity for the roll 60. Alternatively, a machine direction drawing tension may be applied to retract the laminate 40. In any event, if the elastic film 10b is tensioned prior to lamination, it will retract toward its original machine direction length and become shorter in the machine direction, thereby buckling or forming gathers in the laminate. The resulting elastic laminate 40 thus becomes extensible in the machine direction to the extent that the gathers or buckles in the web 50 may be pulled back out flat and allow the elastic film 10b to elongate.

In the embodiment described above, the lamination of the nonwoven web 50 to the film 10b results in a bi-laminate or bilayer material having CD and/or MD extensibility. In another embodiment of the present invention, a tri-laminate or trilayer material may also be formed that contains a nonwoven web on each side of the elastic film. Referring again to FIG. 1, for example, a second nonwoven web (not shown) may be directed to the lamination nip to contact the side surface of the film 10b opposite the side to which the first nonwoven web 50 was laminated. The second nonwoven web may or may not be extensible in one or more directions.

While not shown here, various additional potential processing and/or finishing steps known in the art, such as slitting, treating, aperturing, printing graphics, or further lamination of the elastic laminate into a composite with other materials, such as other films or other nonwoven layers, may be performed without departing from the spirit and scope of the invention. In addition, the elastic laminates formed by the method of the present invention are highly suited for use in medical care products, wipers, protective wear garments, mortuary and veterinary products, and personal care products. Examples of such products include, but are not limited to, medical and health care products such as surgical drapes, gowns and bandages, protective workwear garments such as coveralls and lab coats, and infant, child and adult personal care absorbent articles, such as diapers, training pants, incontinence garments and pads, sanitary napkins, wipes, and so forth.

### EXAMPLE 1

The ability to form an elastic laminate from an elastic film and a fibrous nonwoven web in accordance with the present invention was demonstrated. The fibrous nonwoven web was a polypropylene spunbond web having a basis weight of 20 grams per square meter and produced by BBA Fiberweb of Simpsonville, S.C. under the trade designation Sofspan® 120. The percent stretch of the spunbond web in the cross-machine direction was 25% when subjected to a force of 1,000 grams per 3 inches. The elastic film was a multi-layered film having an “skin-core-skin” structure. The core comprised 96 wt. % of the film and the skin layers comprised 4 wt. % of the film. The core was formed from 95 wt. % of a polyolefin elastomer and 5 wt. % of an antiblocking agent. The polyolefin elastomer was a linear low density polyethylene (LLDPE) obtained from Dow Chemical under the name AFFINITY® EG 8200G (density of 0.870 grams per cubic centimeter and a melt flow rate of 5.0 g/10 min). The antiblocking agent was formed from 20 wt. % diatomaceous earth (Celite 263 from Celite Corp.) and 80 wt. % of a low density polyethylene elastomer obtained from Dow Chemical under the name AFFINITY® EG 8185 (density of 0.885 grams per cubic centimeter and a melt flow rate of 30.0 g/10 min). The skin layers were formed from 100 wt. % of a low density polyethylene obtained from Dow Chemical under the name “Dow Polyethylene 4012.”

The multi-layered elastic film was formed by casting the polymer composition onto a chill roll (set to a temperature of 21° C.) at an unstretched basis weight of approximately 44 grams per square meter. The casting speed was 129 feet per minute. The film was supplied to a lamination nip where it was laminated to the spunbond web with an adhesive. The adhesive was applied with a slot coat adhesive system obtained from Nordson Corporation of Dawsonville, Ga. under the name “Nordson BC-62 Porous Coat.” The adhesive was obtained from Huntsman Polymers of Houston, Tex. under the name “Rextac 2730”, and was applied to the spunbond web at an add-on level of 1.5 grams per square meter.

Once formed, the laminate was then introduced into a nip of intermeshing grooved steel rolls, such as shown in FIGS. 1-3, to stretch the laminate in the cross machine direction. Each groove was formed with a depth of 0.51 centimeters and with a peak to peak distance of 0.31 centimeters, thereby resulting in a maximum draw ratio of 3.4×. In this example, the laminate was stretched using a groove roll engagement of 0.34 centimeters. The grooved steel rolls were heated to a temperature of 125° F. The laminate was then introduced into a retraction and annealing unit where the film side of the laminate contacted four (4) temperature controlled rolls. The first three rolls were heated to a temperature of 49° C., and the fourth roll was cooled to a temperature of 16° C. to set the final stretch material properties. Finally, the laminate was transferred with minimal retraction to the winder for a final basis weight of approximately 60 grams per square meter.

Once formed, the resulting laminate was tested using a cyclical testing procedure. In particular, a single cycle testing was utilized to 100% defined elongation. For this test, the sample size was 3 inches in the MD and 6 inches in the CD. The grip size had a width of 3 inches and the grip separation was 3 inches. The samples were loaded such that the cross-machine direction of the sample was in the vertical direction. A preload of approximately 10 to 15 grams was set. The test pulled the sample at 20 inches/min (500 mm/min) to 100 percent elongation (3 inches in addition to the 3 inch gap), and then immediately (without pause) returned to the zero point (the 3 inch gauge separation). The testing was done on a Sintech Corp. constant rate of extension tester 2/S with a Renew MTS mongoose box (control) using TESTWORKS 4.07b software. (Sintech Corp, of Cary, N.C.). The tests were conducted under ambient conditions. The results are set forth below in Table 1.

TABLE 1
Properties of the Laminate

| Extension | Extension | Retraction | Retraction | |
|---|---|---|---|---|
| Load @ 30% | Load at 50% | Load @ 30% | Load @ 50% | |
| (gf) | (gf) | (gf) | (gf) | % Set |
| 720 | 1040 | 101 | 259 | 18.7 |

### EXAMPLE 2

The ability to form an elastic laminate from an elastic film and a fibrous nonwoven web in accordance with the present invention was demonstrated. Specifically, the process of Example 1 was utilized to form the laminate, except that a groove roll engagement of 0.38 centimeters was utilized.

### EXAMPLE 3

The ability to form an elastic laminate from an elastic film and a fibrous nonwoven web in accordance with the present invention was demonstrated. Specifically, the process of Example 1 was utilized to form the laminate, except that a groove roll engagement of 0.43 centimeters was utilized.

### EXAMPLE 4

The ability to form an elastic laminate from an elastic film and a fibrous nonwoven web in accordance with the present invention was demonstrated. The spunbond web was the same as in Example 1. The elastic film was a multi-layered film having an “skin-core-skin” structure. The core comprised 96 wt. % of the film and the skin layers comprised 4 wt. % of the film. The core was formed from 95 wt. % of a polyolefin elastomer and 5 wt. % of an antiblocking agent. The polyolefin elastomer was a linear low density polyethylene (LLDPE) obtained from Dow Chemical under the name AFFINITY® EG 8200G (a density of 0.870 grams per cubic centimeter and a melt flow rate of 5.0 g/10 min). The antiblocking agent of the core layer was formed from 70 wt. % titanium dioxide and 30 wt. % of a low density polyethylene elastomer obtained from Dow Chemical under the name AFFINITY® EG 8185 (density of 0.885 grams per cubic centimeter and a melt flow rate of 30.0 g/10 min). The skin layers were formed from 95 wt. % of a low density polyethylene obtained from Dow Chemical under the name “Dow Polyethylene 4012” and 5 wt. % of an antiblocking agent. The antiblocking agent was formed from 20 wt. % diatomaceous earth (Celite 263, Celite Corp.) and 80 wt. % of AFFINITY® EG 8185.

The multi-layered elastic film was formed by casting the polymer composition onto a chill roll (set to a temperature of 21° C.) at an unstretched basis weight of approximately 90 grams per square meter. The casting speed was 100 feet per minute. The film was then introduced into a Machine Direction Orienter (MDO) to stretch the film 2.8 times its original length (without heating) at a line speed of 280 feet per minute. The film was retracted 0% resulting in a stretched basis weight of approximately 52 grams per square meter. The stretched film was supplied to a lamination nip where it was laminated to the spunbond web with an adhesive. The adhesive was applied with a slot coat adhesive system obtained from Nordson Corporation of Dawsonville, Ga. under the name “Nordson BC-62 Porous Coat.” The adhesive was obtained from Bostik Findley, Inc, of Wauwatosa, Wis. under the name “H9375-01”, and was applied to the spunbond web at an add-on level of 2.0 grams per square meter.

Once formed, the laminate was then introduced into a nip of intermeshing grooved steel rolls, such as shown in FIGS. 1-3, to stretch the laminate in the cross machine direction. Each groove was formed with a depth of 0.51 centimeters and with a peak to peak distance of 0.31 centimeters, thereby resulting in a maximum draw ratio of 3.4×. In this example, the laminate was stretched using a groove roll engagement of 0.38 centimeters. The laminate was then introduced into a retraction and annealing unit where the film side of the laminate contacted four (4) temperature controlled rolls. The first three rolls were heated to a temperature of 49° C., and the fourth roll was cooled to a temperature of 16° C. to set the final stretch material properties. Finally, the laminate was transferred with minimal retraction to the winder for a final basis weight of approximately 72 grams per square meter.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method for forming a laminate, said method comprising:
forming an elastic film from a polymer composition that comprises an elastomeric polymer;
bonding said elastic film to a nonwoven web material to form a laminate, wherein said nonwoven web material has a percent stretch of no more than 25% when applied with 500 grams-force per 3 inches of said material in the cross-machine or the machine direction; and
mechanically stretching said laminate in at least one direction.

2. The method of claim 1, wherein said elastomeric polymer is selected from the group consisting of polyesters; polyurethanes; polyamides; polyolefins; A-B-A′ or A-B block copolymers, wherein A and A′ are the same or different thermoplastic polymer endblocks, and wherein B is an elastomeric polymer block; and combinations thereof.

3. The method of claim 1, wherein said film comprises a blend of two or more elastomeric polymers.

4. The method of claim 3, wherein one of said elastomeric polymers is a high performance elastomer and another of said elastomeric polymers is a low performance elastomer.

5. The method of claim 1, wherein said elastic film is a cast film.

6. The method of claim 1, wherein said elastic film is a blown film.

7. The method of claim 1, further comprising orienting said film in the machine direction, cross-machine direction, or both.

8. The method of claim 1, wherein said elastic film contains multiple layers.

9. The method of claim 1, wherein said nonwoven web material has a percent stretch of no more than 25% when applied with 750 grams-force per 3 inches of said material in the cross-machine direction or the machine direction.

10. The method of claim 1, wherein said nonwoven web material comprises a spunbond web, a meltblown web, or combinations thereof.

11. The method of claim 10, wherein said nonwoven web material comprises a polyolefin.

12. The method of claim 1, wherein an adhesive is used to bond said elastic film to said nonwoven web material.

13. The method of claim 1, wherein said laminate is mechanically stretched in at least the cross-machine direction.

14. The method of claim 13, further comprising passing said laminate through a nip formed between at least two grooved rolls to incrementally stretch said laminate in the cross-machine direction.

15. The method of claim 1, wherein said laminate is mechanically stretched in at least the machine direction.

16. The method of claim 15, further comprising passing said laminate through a nip formed between at least two grooved rolls to incrementally stretch said laminate in the machine direction.

17. The method of claim 1, wherein said laminate is allowed to retract in the machine direction prior to or during winding onto a roll.

18. The method of claim 1, further comprising bonding said elastic film to a second nonwoven web material.

19. A laminate formed from the method of claim 1.

20. The laminate of claim 19, wherein the laminate is extensible in the cross-machine direction.

21. The laminate of claim 20, wherein the laminate is elastic in the cross-machine direction.

22. The laminate of claim 19, wherein the laminate is extensible in the machine direction.

23. The laminate of claim 22, wherein the laminate is elastic in the machine direction.

24. The laminate of claim 19, wherein the laminate is elastic in both the cross-machine and machine directions.

25. A personal care absorbent article formed from the method of claim 1.

26. A method for forming a laminate, said method comprising:
forming an elastic film from a polymer composition, said polymer composition comprising an elastomeric polymer;
orienting said film in the machine direction to form a uniaxially-oriented elastic film;
bonding said elastic film to a nonwoven web material to form a laminate, wherein said nonwoven web material has a percent stretch of no more than 25% when applied with 500 grams-force per 3 inches of said material in the cross-machine direction; and
passing said laminate through a nip formed between at least two grooved rolls to incrementally stretch said laminate in the cross-machine direction.

27. The method of claim 26, wherein said nonwoven web material comprises a spunbond web, a meltblown web, or combinations thereof.

28. The method of claim 26, wherein said nonwoven web material has a percent stretch of no more than 25% when applied with 750 grams-force per 3 inches of said material in the cross-machine direction.

29. The method of claim 26, wherein said laminate is allowed to retract in the machine direction prior to winding onto a roll.

30. The method of claim 26, further comprising bonding said elastic film to a second nonwoven web material.

31. A laminate formed from the method of claim 26.

32. The laminate of claim 31, wherein the laminate is elastic in the cross-machine direction.

33. The laminate of claim 31, wherein the laminate is elastic in the machine direction.

34. The laminate of claim 31, wherein the laminate is elastic in both the cross-machine and machine directions.

35. A method for forming a laminate, said method comprising:
forming an elastic film from a polymer composition, said polymer composition comprising an elastomeric polymer;
orienting said film in the machine direction to form a uniaxially-stretched elastic film;
bonding said elastic film to said first and second nonwoven web materials to form a laminate, wherein at least one said nonwoven web materials has a percent stretch of no more than 25% when applied with 500 grams-force per 3 inches of said material in the cross-machine direction; and
passing said laminate through a nip formed between at least two grooved rolls to incrementally stretch said laminate in the cross-machine direction.
